(19) United States
(12) Patent Application Publication
(10) Pub. No.: US 2010/0076938 A1
(43) Pub. Date: Mar. 25, 2010

(54) PROTOCOL MISMATCH DETECTION SYSTEM, PROTOCOL MISMATCH DETECTION METHOD, AND PROTOCOL MISMATCH DETECTION PROGRAM

(75) Inventors: Ken HANAZAWA, Tokyo (JP); Kyoji HIRATA, Tokyo (JP); MASAHIRO IWADARE, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/448,820

(22) PCT Filed: Dec. 26, 2007
(86) PCT No.: PCT/JP2007/074889

§ 371 Date: Jul. 9, 2009

(30) Foreign Application Priority Data
Jan. 12, 2007 (JP) 2007-005060

(51) Int. Cl. G06F 17/30; G06F 17/00; G06F 17/27

(52) U.S. Cl. 707/690; 704/9; 707/E17.005; 707/E17.032

(57) ABSTRACT

A protocol mismatch detection system (1) includes: a protocol database (10); input means (11) for inputting data to be accumulated in the protocol database (10); protocol data accumulation means (12) for accumulating the inputted data in the protocol database (10); announced content reception means (13) for receiving an announced content from outside; a protocol mismatch detection means (14) for referencing the protocol database (10) to detect a portion of the announced content received which does not coincide with the protocol of a user in the protocol mismatch detection system (1); and output means (15) for outputting the detected protocol mismatch and the protocol mismatch portion.

### APPLICABLE FIELD IN THE INDUSTRY

The present invention relates to a protocol mismatch detection system, a protocol mismatch detection method, and a protocol mismatch detection program, and more particularly to a system, a method, and a program for detecting a mismatch of a protocol between different groups or individuals.

### BACKGROUND ART

It is important to both of a sender and a receiver to confirm whether an intention of the sender is correctly conveyed to the receiver in communication between different groups or individuals.

As a technique for solving this problem, the method of decreasing misunderstanding (communication error) by pre-unifying a protocol (phrase/expression/custom), and the method of making a confirmation every time when the error could occur are thinkable.

### DISCLOSURE OF THE INVENTION

### Problems to be Solved by the Invention

A first point at issue is that an efficiency in the communication between the groups declines because the protocol differs when the group differs. The reason is that a detecting means that is used when communication abnormality has occurred does not exist.

Thereupon, the present invention has been accomplished in consideration of the above problems, and an object thereof is to provide a technology of capable of resultantly bringing about a correct understanding between different groups by widely notifying the communication abnormality when it has occurred in the communication between them.

### Means to Solve the Problems

The present invention for solving the above-mentioned problems, which is a protocol mismatch detection system, is characterized in including: a protocol database; a protocol data accumulating means for acquiring a content announced by a user, and accumulating it in the foregoing protocol database; an announced content receiving means for receiving the announced content other than the content announced by the foregoing user; and a protocol mismatch detecting means for making a reference to the foregoing protocol database, and detecting a mismatch portion of which a protocol does not coincide with that of the foregoing user, out of the announced content other than the content announced by the foregoing user.

The present invention for solving the above-mentioned problem, which is a protocol mismatch detection system, is characterized in including: a protocol database; a protocol data accumulating means for acquiring a content announced by a user, and accumulating it in the foregoing protocol database; an announced content receiving means for receiving the announced content other than the content announced by the foregoing user; and a protocol mismatch detecting means for making a reference to the foregoing protocol database, and notifying a portion of which a protocol does not coincide with that of foregoing user, out of the announced content other than the content announced by the foregoing user.

The present invention for solving the above-mentioned problem, which is a protocol dictionary preparation system, is characterized in including: a protocol database; a protocol data accumulating means for acquiring a content announced by a user, and accumulating it in the foregoing protocol database; an announced content receiving means for receiving the announced content other than the content announced by the foregoing user; and a protocol dictionary preparing means for preparing a protocol dictionary based upon a mismatch between the announced content other than the content announced by the foregoing user and the content of the foregoing protocol database.

The present invention for solving the above-mentioned problem, which is a protocol mismatch detection method, is characterized in: acquiring a content announced by a user, and accumulating it in a protocol database; receiving the announced content other than the content announced by the foregoing user; and making a reference to the foregoing protocol database, and detecting a mismatch portion of which a protocol does not coincide with that of the foregoing user, out of the announced content other than the content announced by the foregoing user.

The present invention for solving the above-mentioned problem, which is a protocol mismatch detection method, is characterized in including: acquiring a content announced by a user and accumulating it in a protocol database; receiving the announced content other than the content announced by the foregoing user; and making a reference to the foregoing protocol database, and notifying a portion of which a protocol does not coincide with that of foregoing user, out of the announced content other than the content announced by the foregoing user.

The present invention for solving the above-mentioned problem, which is a protocol dictionary preparation method, is characterized in including: acquiring a content announced by a user and accumulating it in a protocol database; receiving the announced content other than the content announced by the foregoing user; and preparing a protocol dictionary based upon a mismatch between the announced content other than the content announced by the foregoing user and the content of the foregoing protocol database.

The present invention for solving the above-mentioned problem, which is a program for detecting a protocol mismatch, is characterized in causing an information processing device to execute the processes of: acquiring a content announced by a user, and accumulating it in a protocol database; receiving the announced content other than the content announced by the foregoing user; and making a reference to the foregoing protocol database, and detecting a mismatch portion of which a protocol does not coincide with that of the foregoing user, out of the announced content other than the content announced by the foregoing user.

The present invention for solving the above-mentioned problem, which is a program for detecting a protocol mismatch, is characterized in causing an information processing device to execute the processes of: acquiring a content announced by a user, and accumulating it in a protocol database; receiving the announced content other than the content announced by the foregoing user; and making a reference to the foregoing protocol database, and outputting an alarm for a portion of which a protocol does not coincide with that of the foregoing user, out of the announced content other than the content announced by the foregoing user.

The present invention for solving the above-mentioned problem, which is a protocol dictionary preparation system for detecting a protocol mismatch, is characterized in including: a protocol data accumulating means for acquiring a content announced by a user, and accumulating it in a protocol database; and a protocol dictionary preparing means for preparing a protocol dictionary for detecting the protocol mismatch based upon the content of the foregoing protocol database.

### AN ADVANTAGEOUS EFFECT OF THE INVENTION

An advantageous effect of the present invention is that the misunderstanding in communication relating to a business can be reduced. The reason is that the unknown phrases being included in the content announced from an outside are detected based upon the past announced content (for example, a business history), and the mismatch of the protocol is detected.

### BRIEF DESCRIPTION OF THE DRAWINGS

FIG. 1 is a view illustrating a configuration of the entirety of the protocol mismatch detection system relating to a first embodiment.

FIG. 2 is an operational flowchart of the protocol mismatch detection system.

FIG. 3 is a view illustrating a configuration of the entirety of the protocol mismatch detection system relating to an example 1.

FIG. 4 is a view for explaining the example 1.

FIG. 5 is a view for explaining the example 1.

FIG. 6 is a view illustrating a configuration of the entirety of the protocol mismatch detection system relating to a second embodiment.

FIG. 7 is a view illustrating a configuration of the entirety of the protocol mismatch detection system relating to an example 2.

FIG. 8 is a view for explaining the example 2.

FIG. 9 is a view illustrating another configuration of the entirety of the protocol mismatch detection system relating to the second embodiment.

FIG. 10 is a view illustrating a configuration of the entirety of the protocol mismatch detection system relating to a third embodiment.

FIG. 11 is a view illustrating a configuration of the entirety of the protocol mismatch detection system relating to an example 3.

FIG. 12 is a view for explaining the example 3.

FIG. 13 is a view illustrating a configuration of the entirety of the protocol mismatch detection system 1 relating to a fourth embodiment.

FIG. 14 is a view illustrating a configuration of the entirety of the protocol mismatch detection system relating to an example 4.

FIG. 15 is a view for explaining the example 4.

### DESCRIPTION OF NUMERALS

10 and 20 protocol databases
11 inputting means
12 protocol data accumulating means
13 announced content receiving means
14 protocol mismatch detecting means
15 outputting means

### BEST MODE FOR CARRYING OUT THE INVENTION

Special features of the present invention will be explained.

The present invention is a protocol mismatch detection system, comprising: a protocol database; a protocol data accumulating means for acquiring a content announced by a user, and accumulating it in said protocol database; an announced content receiving means for receiving the announced content other than the content announced by said user; and a protocol mismatch detecting means for making a reference to said protocol database, and detecting a mismatch portion of which a protocol does not coincide with that of said user, out of the announced content other than the content announced by said user.

Also, the protocol mismatch detecting means notifies the mismatch of the protocol.

The present invention is a protocol mismatch detection system, comprising: a protocol database; a protocol data accumulating means for acquiring a content announced by a user, and accumulating it in said protocol database; an announced content receiving means for receiving the announced content other than the content announced by said user; and a protocol mismatch detecting means for making a reference to said protocol database, and notifying a portion of which a protocol does not coincide with that of said user, out of the announced content other than the content announced by said user.

Also, the announced content, for example, is one of an electronic mail, a specification, a conference document, minutes of a proceeding, and a content announced in a conference, or a combination thereof.

Also, the protocol mismatch detecting means identifies a target word or a target expression of the protocol mismatch by one of a word collocation frequency, a word mutual information quantity, and a synonym dictionary, or a combination thereof.

Also, the protocol mismatch detecting means makes a reference to the protocol database of said user, and the protocol database other than the protocol database of said user, and detecting a mismatch portion of which a protocol does not coincide with that of said user, out of the announced content other than the content announced by said user.

Also, the present invention comprises a protocol dictionary prepared based upon the content of the protocol database; and the protocol mismatch detecting means detects the mismatch of the protocol by employing said protocol dictionary.

Also, the present invention comprises a protocol dictionary prepared based upon the content of the protocol database; and the protocol mismatch detecting means detects a word or an expression of which the protocol coincides, or a word or an expression of which the protocol does not coincide by employing said protocol dictionary.

Also, the protocol mismatch detecting means detects the mismatch of the protocol by employing the protocol database of its own system and the protocol database being publicly opened over a network.

Also, the present invention comprises an announced content transmitting means for transmitting data of the protocol for which the mismatch has been detected to said protocol database being publicly opened over the network; and accumulates said transmitted data in said protocol database being publicly opened over the network.

Also, the present invention comprises a notifying means for notifying said notification to the user having received said announced content.

Also, the present invention comprises a notifying means for notifying said notification to the user having announced said announced content.

Also, the present invention comprises a protocol mismatch collecting means for collecting the detection of the protocol mismatch.

Also, the present invention comprises: a protocol database; a protocol data accumulating means for acquiring a content announced by a user, and accumulating it in said protocol database; an announced content receiving means for receiving the announced content other than the content announced by said user; and a protocol dictionary preparing means for preparing a protocol dictionary based upon a mismatch of the announced content other than the content announced by said user and the content of said protocol database.

Also, the present invention is a protocol mismatch detection method, comprising: acquiring a content announced by a user, and accumulating it in a protocol database; receiving the announced content other than the content announced by said user; and making a reference to said protocol database, and detecting a mismatch portion of which a protocol does not coincide with that of said user, out of the announced content other than the content announced by said user.

Also, the present invention comprises notifying a mismatch of the protocol.

Also, the present invention is a protocol mismatch detection method, comprising: acquiring a content announced by a user, and accumulating it in a protocol database; receiving the announced content other than the content announced by said user; and making a reference to said protocol database, and notifying a portion of which a protocol does not coincide with that of said user, out of the announced content other than the content announced by said user.

Also, the announced content, for example, is one of an electronic mail, a specification, a conference document, minutes of a proceeding, and a content announced in a conference, or a combination thereof.

Also, the detection of the protocol mismatch is to identify a target word or a target expression of the protocol mismatch by one of a word collocation frequency, a word mutual information quantity, and a synonym dictionary, or a combination thereof, and to detect the protocol mismatch.

Also, the detection of the protocol mismatch is to make a reference to the protocol database of said user, and the protocol database other than the protocol database of said user, and to detect a mismatch portion of which a protocol does not coincide with that of said user, out of the announced content other than the content announced by said user.

Also, the detection of the protocol mismatch is to detect the mismatch of the protocol by employing a protocol dictionary prepared based upon the content of the protocol database.

Also, the detection of the protocol mismatch is to detect a word or an expression of which the protocol coincides, or a word or an expression of which the protocol does not coincide by employing a protocol dictionary prepared based upon the content of the protocol database.

Also, the detection of the protocol mismatch is to detect the mismatch of the protocol by employing the protocol database of its own system and the protocol database being publicly opened over a network.

Also, the present invention comprises accumulating data of the protocol for which the mismatch has been detected in said protocol database being publicly opened over the network.

Also, the present invention comprises notifying said notification to the user having received said announced content.

Also, the present invention comprises notifying said notification to the user having announced said announced content.

Also, the present invention comprises collecting the detection of the protocol mismatch and outputting a collection result.

Also, the present invention is a protocol dictionary preparation method, comprising: acquiring a content announced by a user, and accumulating it in a protocol database; and receiving the announced content other than the content announced by said user; and preparing a protocol dictionary based upon a mismatch of the announced content other than the content announced by said user and the content of said protocol database.

Also, the present invention is a program for detecting a mismatch of a protocol, said program causing an information processing device to execute the processes of: acquiring a content announced by a user, and accumulating it in a protocol database; receiving the announced content other than the content announced by said user; and making a reference to said protocol database, and detecting a mismatch portion of which a protocol does not coincide with that of said user, out of the announced content other than the content announced by said user.

Also, the present invention causes the information processing device to execute a process of notifying the mismatch of the protocol.

Also, the present invention is a program for detecting a mismatch of a protocol, said program causing an information processing device to execute the processes of: acquiring a content announced by a user, and accumulating it in a protocol database; receiving the announced content other than the content announced by said user; and making a reference to said protocol database, and notifying a portion of which a protocol does not coincide with that of said user, out of the announced content other than the content announced by said user.

Also, the present invention is a protocol dictionary preparation system for detecting a protocol mismatch, said system comprising: a protocol data accumulating means for acquiring a content announced by a user, and accumulating it in a protocol database; and a protocol dictionary preparing means for preparing a protocol dictionary for detecting the protocol mismatch based upon the content of said protocol database.

The detailed embodiment of the present invention will be explained.

### First Embodiment

The first embodiment of the present invention will be explained.

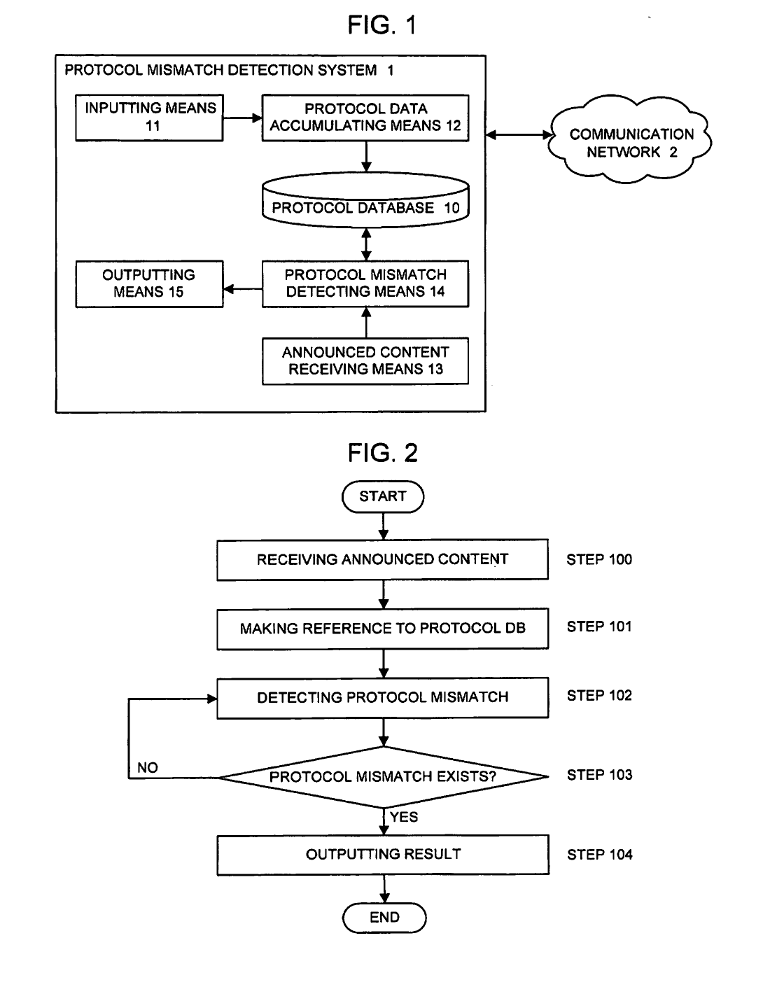

FIG. 1 is a view illustrating a configuration of the entirety of the protocol mismatch detection system relating to the first embodiment.

The protocol mismatch detection system 1 includes a protocol database 10, an inputting means 11 for inputting data being accumulated in the protocol database 10, a protocol data accumulating means 12 for accumulating the inputted data in the protocol database 10, an announced content receiving means 13 for receiving a content announced by an outside, a protocol mismatch detecting means 14 for making a reference to the protocol database 10, and detecting a portion of which the protocol does not coincide with that of the user of the protocol mismatch detection system 1, out of the received announced content, and an outputting means 15 for outputting (notifying) the detected protocol mismatch and the detected protocol mismatch portion. Additionally, the outputting means 15 may be adapted to output only one of a notification of the protocol mismatch detection and a notification of the detected protocol mismatch portion.

Herein, the so-called announcement signifies the notifying a voice, a document, etc. to other persons by employing an electronic means, and the so-called electronic means includes not only a telephone and an electronic mail but also a television conference employing a communication means.

The data inputted by the inputting means 11, which is data associated with the announcement, could be not only electronic data such as a mail, a blog, and a document used and prepared by the user of the protocol mismatch detection system 1 (a group to which the user belongs is acceptable), but also a voice etc. The inputting means 11 that can input these items of the data into the protocol database 10 is acceptable, and it is, for example, a keyboard, a mouse, a telephone system, a microphone, an interface for automatically incorporating the prepared mail and document, etc. Additionally, when the telephone system or the microphone is employed, it is thinkable to build-in a voice recognition device into the inputting means 11.

The protocol data accumulating means 12 is an accumulating means for converting the data inputted from the inputting means 11 into data of the technique of the protocol database 10, and accumulating it. For example, when the protocol database 10 has stored a certain word, and a word being collocated with this word correspondingly to each other, the protocol data accumulating means 12 makes a morphological analysis for the inputted data, or the like, and accumulates each word and a word being collocated with the above each word correspondingly to each other in the protocol database 10. Additionally, when the processes such as the morphological analysis and the collocation are performed by the protocol mismatch detecting means 14, which is described later, the protocol data accumulating means 12 may accumulate the data inputted from the inputting means 11 in the protocol database 10 without analyzing it.

Further, the protocol data accumulating means 12 may be configured to acquire not only the data incorporated from the inputting means 11 but also the data used and prepared by the user (the group to which the user belongs is acceptable) while taking an auto-cruising control like a retrieval engine.

The announced content receiving means 13 receives files etc. of applications such as an electronic mail and a word processor, and a speech (voice) of a communication partner, converts this data into data of a format such that the protocol mismatch detecting means 14 can detect the mismatch of the protocol, and outputs it.

The protocol mismatch detecting means 14 makes a reference to the protocol database 10, collates the data stored in the protocol database 10 with the received announced content, and determines whether the mismatch of the protocol exists. For example, when there exists the word, which has not been used by the user, in the announced content, namely, there exists the word, which has not been registered as a word being utilized by the user in the protocol database 10, the protocol mismatch detecting means 14 determines that the mismatch of the protocol exists. When it has been detected that the mismatch of the protocol exists, its result is outputted. Additionally, the portion of which the protocol does not coincide, out of the announced content, may be outputted simultaneously with the output result.

The outputting means 15, which is a means for outputting the result coming from the protocol mismatch detecting means 14, is for example, a display, a printer, or the like.

Next, one example of an operation of the protocol mismatch detection system 1 in accordance with the present invention will be explained by employing FIG. 1 and FIG. 2. Additionally, it is assumed that the data inputted by the inputting means 11 has been pre-stored in the protocol database 10 by the protocol data accumulating means 12.

At first, when the announced content receiving means 13 receives the announced content from an outside (Step 100), the protocol mismatch detecting means 14 makes a reference to the protocol database 10 (Step 101), and determines whether a mismatch of the protocol exists between the data registered in the protocol database 10 and the received announced content (Step 102).

When no mismatch of the protocol exists in the announced content (Step 103), the protocol mismatch detecting means 14 returns to the Step 102, and continues to perform a detecting process.

On the other hand, when the mismatch of the protocol exists in the announced content, the protocol mismatch detecting means 14 outputs an alarm for the protocol mismatch to the outputting means 15, and the outputting means 15 outputs a result (Step 104).

### Example 1

The example 1 corresponding to the first embodiment will be explained. Additionally, in the example 1, the announced content will be explained as a business content relating to a business. Further, the mail is targeted as a communication means between the groups; however a telephone correspondence, a conference, or the like is acceptable.

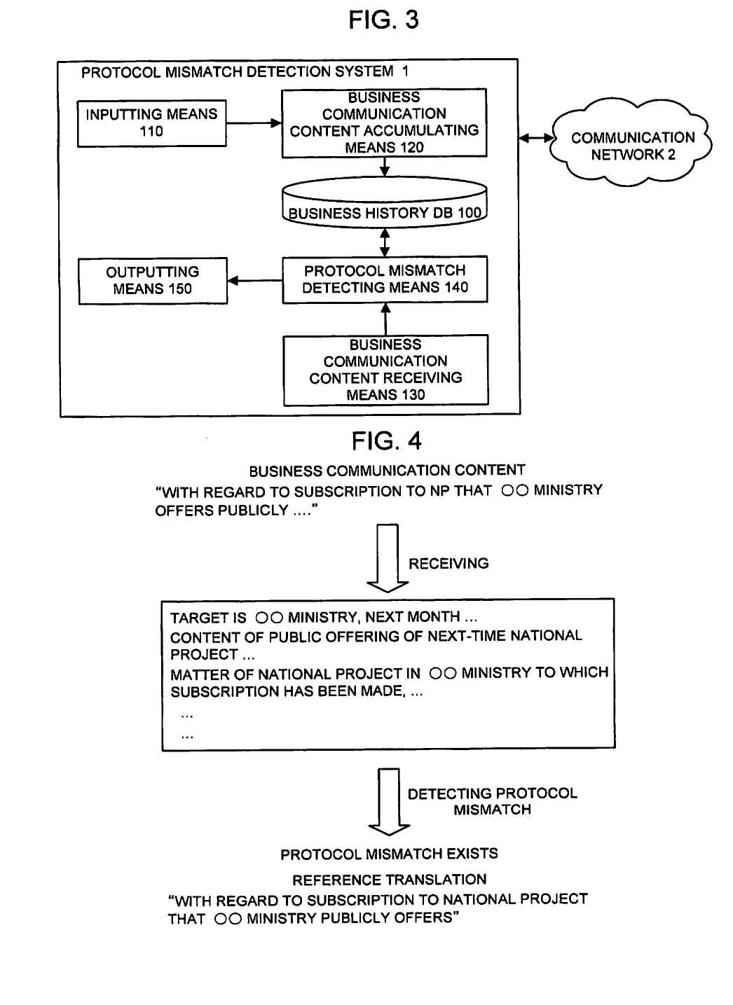

FIG. 3 is a view illustrating a configuration of the entirety of the protocol mismatch detection system relating to the example 1.

The protocol mismatch detection system 1 of the example 1 includes an inputting means 110 for inputting a business communication content, a business history database 100, a business history accumulating means 120 for accumulating the inputted business communication content in the business history database 100, a business communication content receiving means 130 for receiving the business communication content from an outside, a protocol mismatch detecting means 140 for making a reference to the business history database 100, and detecting the portion of which the protocol does not coincide with that of the user of the protocol mismatch detection system 1, out of the received business communication content, and an outputting means 150 for outputting an alarm for the protocol mismatch.

Additionally, the inputting means 110 for inputting the business communication content corresponds to the inputting means 11, the business history database 100 to the protocol database 10, the business history accumulating means 120 to the protocol data accumulating means 12, the business communication content receiving means 130 to the announced content receiving means 13, the protocol mismatch detecting means 140 to the protocol mismatch detecting means 14, and the outputting means 150 to the outputting means 15, respectively. Additionally, it is assumed that the business history prepared from the data such as the mail etc. prepared by the user has been stored in the business history database 100.

Hereinafter, a specific operation in the configuration as mentioned above will be explained by employing FIG. 4.

It is assumed that Mr. A (a user of the protocol mismatch detection system) belonging to a certain group has received the business communication content saying “with regard to a subscription to an NP (National Project) that ◯◯ Ministry offers publicly . . . . ” from Mr. B of a group of a corporation partner. Herein, it is assumed that the content saying “a content of the public offering of the next-time national project . . . ”, and “a matter of the national project in ◯◯ Ministry to which a subscription has been made, . . . ” have been accumulated in the business history database 100 as the past business history, and in addition to this, the expression “NP” did not existed, or the quantity of the above expression is a constant or less.

Then, the protocol mismatch detecting means 140 determines that the protocol mismatch exists, and an alarm saying the effect that the protocol mismatch exists, is outputted, for example, to the screen of Mr. A. At this time, “NP”, being a portion of the protocol mismatch, may be notified. In addition hereto, the detected alarm may be outputted to Mr. B, being a sender of the mail.

Further, it is also possible to accumulate a result of the mismatch again in the business history database, and to re-utilize it. As a unit of the group, an enterprise/a department within an enterprise/an individual within a department are thinkable.

In addition hereto, a configuration may be made so that a translating means is installed, an expression of the detected mismatch is translated, and its result is outputted together with the alarm. For example, it is determined that a possibility that the expression equivalent to “NP” is “national project” is high based upon the word collocation information because, herein, the phrases/expressions such as “◯◯ Ministry”, “public offering”, and “subscription” are related with “national project”, and a translation candidate, which assumes that “NP” means “national project”, is outputted together with the alarm. Additionally, in the foregoing example, the word collocation information was employed; however the statistical technique is not limited hereto, and the statistical technique other than it, for example, a mutual information quantity may be employed. A rule-based technique, for example, a technique of using a synonym dictionary instead of the statistical technique is also thinkable. Further, a combination of both techniques may be employed.

Continuously, another example corresponding to the first embodiment will be explained. Additionally, in another example, the announced content will be explained as a business content relating to a business. Further, the television conference is exemplified as a communication means between the groups; however the mail, the telephone correspondence, the normal conference, or the like is acceptable.

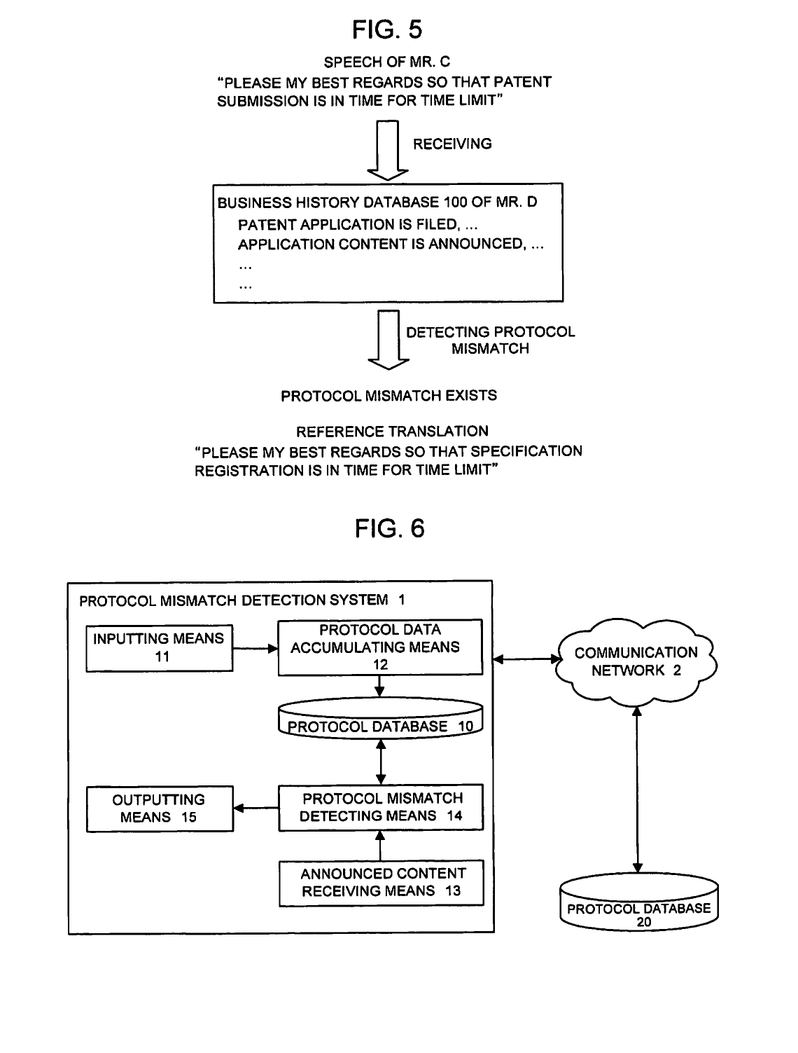

FIG. 5 is a view for explaining an operation of the protocol mismatch detection system relating to another example. Additionally, it is assumed that a company to which Mr. C and Mr. D making an entrance below belong enforces an institution for pre-registering specifications associated with a patent application into a management system when filing a patent application.

At first, it is assumed that Mr. D, being another conference participant, is listening to the content being spoken by a presenter Mr. C in the TV conference in which Mr. C and Mr. D are participating.

When Mr. D has received the speech of Mr. C saying “Please my best regards so that patent submission is in time for a time limit”, the protocol mismatch detecting means 140 makes a reference to the business history database 100 of Mr. D, and determines that the protocol mismatch exists when the word/expression “patent submission” does not exist, or the appearance quantity of the above word/expression is a constant value or less even though it exists, and the effect is outputted, for example, to the screen of the television conference of Mr. D.

Further, the detected alarm may be outputted to Mr. C, being a speaker, may be outputted to another participant in the conference, and may be outputted to a superior of Mr. C and Mr. D, being a person concerned who is not participating in the conference.

Further, it is also possible to accumulate a result of the mismatch again in the business history database, and to re-utilize it. As a unit of the group, an enterprise/a department within an enterprise/an individual within a department are thinkable.

In addition hereto, a configuration may be made so that a translating means is installed, an expression of the detected mismatch is translated, and its result is outputted together with the alarm. For example, the translation for converting “patent submission”, being a speech of Mr. C, into “specification registration” may be made. In the foregoing example, it was assumed that the word collocation information was employed; however the statistical technique is not limited hereto, and the statistical technique other than it, for example, a mutual information quantity may be employed. The rule-based technique, for example, the technique of using a synonym dictionary instead of the statistical technique is also thinkable. Further, a combination of both techniques may be employed.

### Second Embodiment

The second embodiment will be explained.

FIG. 6 is a view illustrating a configuration of the entirety of the protocol mismatch detection system 1 relating to the second embodiment.

A point in which the protocol mismatch detection system 1 of the second embodiment differs from the protocol mismatch detection system 1 of the first embodiment is that the protocol mismatch detecting means 14 makes a reference to the protocol database 10 of its own system and a protocol database 20 of a communication partner, and detects the mismatch of the protocol. This makes it possible to raise a detection precision of the protocol mismatch all the more as compared with the case of the first embodiment.

### Example 2

The example 2 corresponding to the second embodiment will be explained. Additionally, in the example 2, the conference is targeted as a communication form, and the microphone and the display are selected as the inputting means 11 and the outputting means 15, respectively.

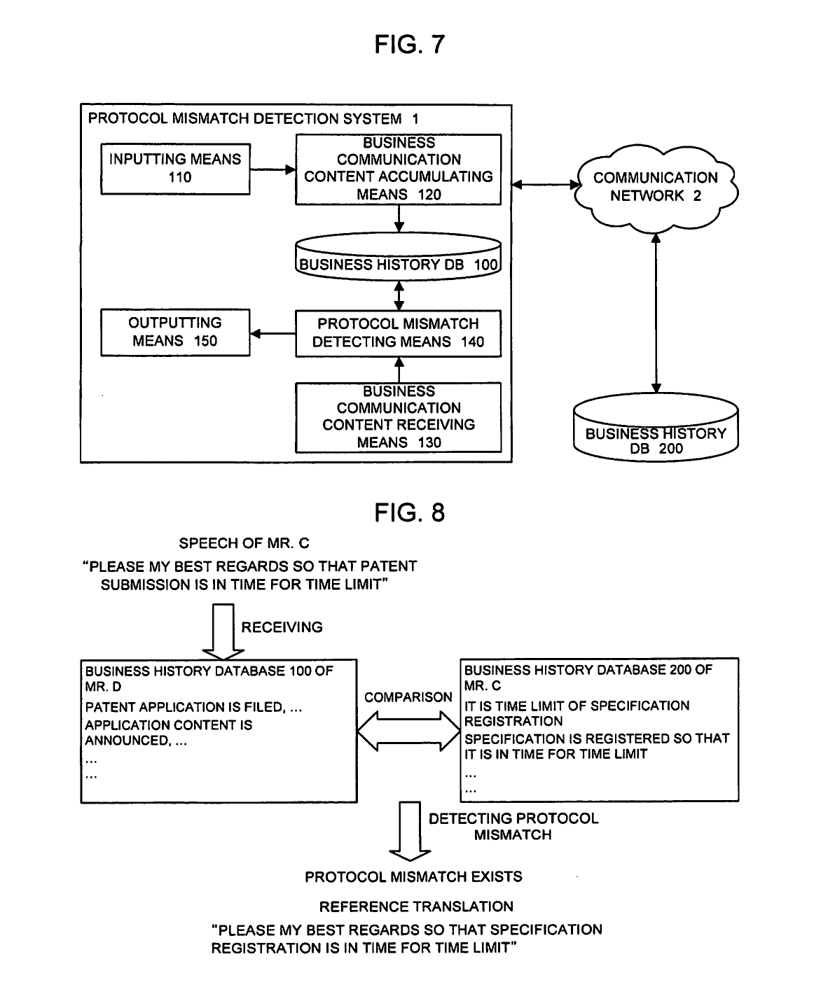

FIG. 7 is a view illustrating a configuration of the entirety of the protocol mismatch detection system relating to the example 2.

The protocol mismatch detection system 1 of the example 2 includes an inputting means 110 for inputting a business communication content, a business history database 100 of its own system, a business history database 200 of the protocol mismatch detection system of a communication destination, a business history accumulating means 120 for accumulating the inputted business communication content in the business history database 100, a business communication content receiving means 130 for receiving the business communication content from an outside, a protocol mismatch detecting means 140 for making a reference to the business history databases 100 and 200, and detecting the mismatch of the protocol of the received business communication content, and an outputting means 150 for outputting a detection result by the protocol mismatch detecting means 140.

Additionally, the inputting means 110 for inputting the business communication content corresponds to the inputting means 11, each of the business history databases 100 and 200 to the protocol database 10, the business history accumulating means 120 to the protocol data accumulating means 12, the business communication content receiving means 130 to the announced content receiving means 13, the protocol mismatch detecting means 140 to the protocol mismatch detecting means 14, and the outputting means 150 to the outputting means 15, respectively. Additionally, it is assumed that the business history prepared from the data such as the mail prepared by the user has been stored in the business history database 100.

Hereinafter, a specific operation in the configuration as mentioned above will be explained by employing FIG. 8. Additionally, it is assumed that a company to which Mr. C and Mr. D making an entrance below belong enforces an institution for pre-registering specifications associated with a patent application into a management system when filing a patent application.

At first, it is assumed that Mr. D, being another conference participant, is listening to the content being spoken by a presenter Mr. C in the TV conference in which Mr. C and Mr. D are participating.

When Mr. D has received the speech of Mr. C saying “Please my best regards so that patent submission is in time for a time limit”, the protocol mismatch detecting means 140 compares the business history database 100 of Mr. C with the business history database 200 of Mr. D, and detects that a mismatch exists between “specification registration”, being an intention of Mr. C, and “patent application”, being an understanding of Mr. D, for example, from the word collocation information with the words such as “patent”, “time limit” and “being in time for”. And, the alarm for the mismatch of the protocol is outputted, for example, to the screen of the television conference of Mr. D. At this time, “specification registration”, being a portion of which the protocol does not coincide, may be outputted. In addition hereto, the detected alarm may be outputted to Mr. C, being a speaker, and may be outputted to other participants of the conference, and may be outputted, for example, to a superior of Mr. C and Mr. D, being a person concerned who is not participating in the conference.

Outputting the detected alarm to Mr. C allows Mr. C to know that his own word or expression has not been conveyed, which brings about an effect for urging Mr. C to change the above word or expression. Further, Mr. C and Mr. D argue about the mismatch of the above word or expression, thereby bringing about an effect as well of deepening an understanding of the intention.

In the foregoing example, the word collocation information was employed for detecting the protocol mismatch; however the statistical technique is not limited hereto, and the statistical technique other than it, for example, a mutual information quantity may be employed. The rule-based technique, for example, the technique of using a synonym dictionary instead of the statistical technique is also thinkable. Further, a combination of both techniques may be employed.

Further, it is also possible to accumulate a result of the mismatch again in the business history database, and to re-utilize it. As a unit of the group, an enterprise/a department within an enterprise/an individual within a department are thinkable.

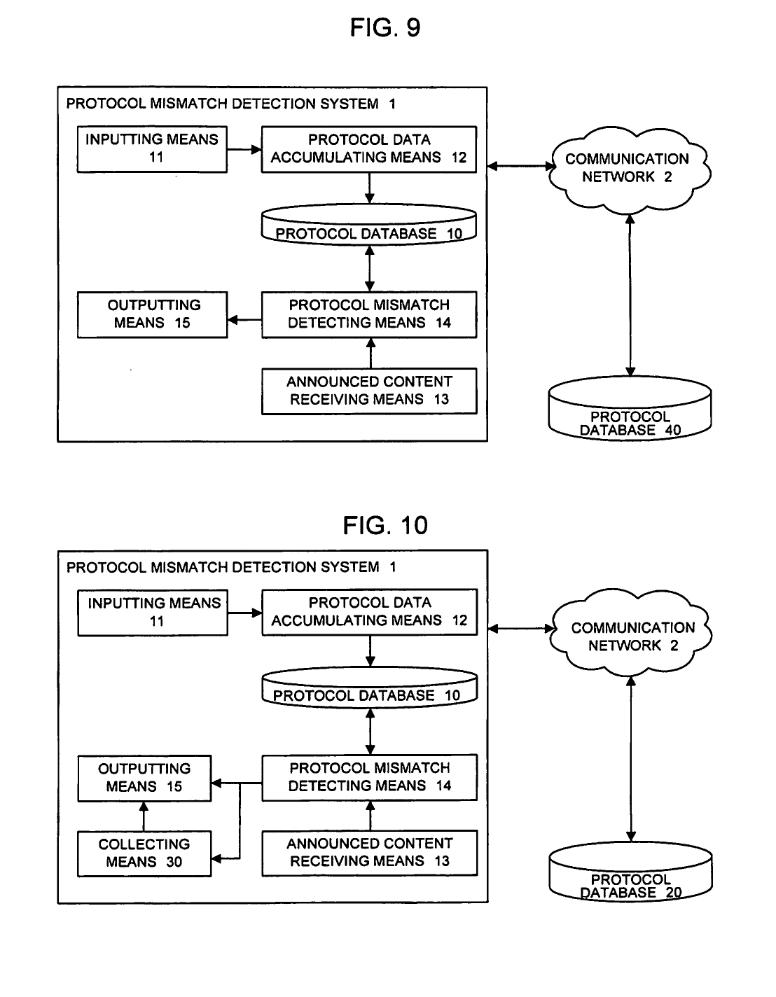

Further, in this example, the protocol mismatch detecting means 14 was adapted to make a reference to the protocol database 10 of its own system and the protocol database 20 of the communication partner; however the protocol mismatch detecting means 14 may be configured to make a reference to a protocol database 40 being publicly opened over a network instead of the protocol database 20 of the communication partner, as shown in FIG. 9, and to detect the mismatch of the protocol.

In addition hereto, a configuration may be made so that a translating means is installed, the detected expression of the mismatch is translated, and its result is outputted together with the alarm. For example, the translation for converting “patent submission”, being a speech of Mr. C, into “specification registration” may be made.

### Third Embodiment

The third embodiment will be explained.

FIG. 10 is a view illustrating a configuration of the entirety of the protocol mismatch detection system 1 relating to the third embodiment.

A point in which the protocol mismatch detection system 1 of the third embodiment differs from the protocol mismatch detection system 1 of each of the first embodiment and the second embodiment is to include a collecting means 30 for collecting the number of times of the protocol mismatches detected by the protocol mismatch detecting means 14. Including the collecting means 30 makes it possible to compute understandability of the participants in the communication such as the conference because the total number of times of the protocol mismatches can be grasped.

### Example 3

The example 3 corresponding to the third embodiment will be explained. Additionally, in the example 3, the conference is targeted as a communication form, and the microphone and the display are selected as the inputting means 11 and the outputting means 15, respectively.

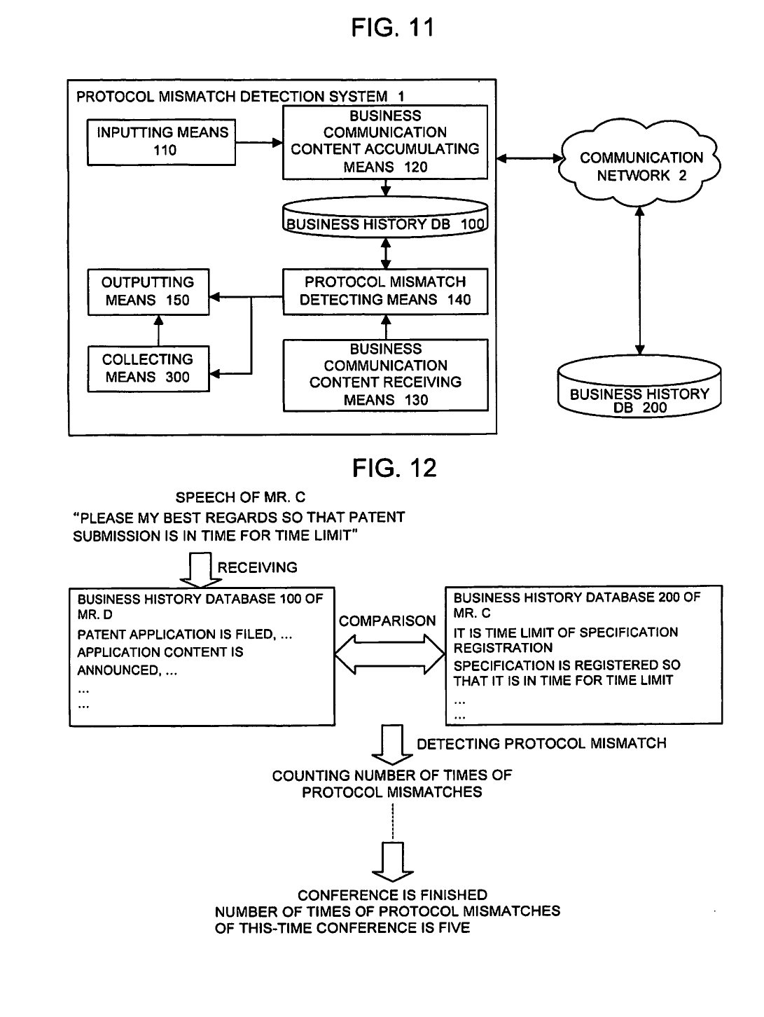

FIG. 11 is a view illustrating a configuration of the entirety of the protocol mismatch detection system 1 relating to the example 3.

The protocol mismatch detection system 1 of the example 3 includes an inputting means 110 for inputting a business communication content, a business history database 100 of its own system, a business history database 200 of the protocol mismatch detection system of a communication destination, a business history accumulating means 120 for accumulating the inputted business communication content in the business history database 100, a business communication content receiving means 130 for receiving the business communication content from an outside, a protocol mismatch detecting means 140 for making a reference to the business history databases 100 and 200, and detecting the mismatch of the protocol of the received business communication content, an outputting means 150 for outputting a detection result by the protocol mismatch detecting means 140, and a collecting means 300 for collecting the detection result by the protocol mismatch detecting means 140.

Additionally, the inputting means 110 for inputting the business communication content corresponds to the inputting means 11, each of the business history databases 100 and 200 to the protocol database 10, the business history accumulating means 120 to the protocol data accumulating means 12, the business communication content receiving means 130 to the announced content receiving means 13, the protocol mismatch detecting means 140 to the protocol mismatch detecting means 14, the outputting means 150 to the outputting means 15, and the collecting means 300 to the collecting means 30, respectively.

Hereinafter, a specific operation in the configuration as mentioned above will be explained by employing FIG. 12. Additionally, it is assumed that a company to which Mr. C and Mr. D making an entrance below belong enforces an institution for pre-registering specifications associated with a patent application into a management system when filing a patent application.

At first, it is assumed that Mr. D, being another conference participant, is listening to the content being spoken by a presenter Mr. C in the TV conference in which Mr. C and Mr. D are participating.

When Mr. D has received the speech of Mr. C saying that “Please my best regards so that patent submission is in time for a time limit”, the protocol mismatch detecting means 140 compares the business history database 100 of Mr. C with the business history database 200 of Mr. D, and detects that a mismatch exists between “specification registration” being an intention of Mr. C, and “patent application”, being an understanding of Mr. D, for example, from the word collocation information with the words such as “patent”, “time limit” and “being in time for”. And, the alarm for the mismatch of the protocol is outputted, for example, to the screen of the television conference of Mr. D. At this time, “specification registration”, being a portion of which the protocol does not coincide, may be notified.

On the other hand, the collecting means 300, upon receipt of the detection result of the protocol mismatch by the protocol mismatch detecting means 140, counts the number of times of the protocol mismatches. And, after the conference is finished, the collecting means 300 outputs its result (count number) to the screen of the television conference. Doing so gives rise to an effect of showing the fact that the smaller the number of times of the detection of the mismatches is, the higher the understandability of the participants in the above conference is, and the result can be utilized as a yardstick for understandability of the conference. Additionally, the collecting means 300 may carry out not only the simple counting of the number of times of the detection of the mismatches, but also the collection of the number of times of the detection of the mismatches for each participant in the conference and the by-expression collection in the ascending order of the number of times of the mismatches. By doing so, reflection into the expression of the announced content in the coming conference is enabled, namely, the expression such that the protocol mismatch is prevented from occurring is employed.

Additionally, the collection result may be outputted to all of the participants, and for each participant, the collection result of the above participant may be outputted.

It is also possible to accumulate the collection result by the collecting means 300 in the database, and to utilize the accumulated data as a reference for the content being announced in future.

In addition hereto, a configuration may be made so that a translating means is installed, the detected expression of the mismatch is translated, and its result is outputted together with the collection result.

In the foregoing example, it was assumed that the word collocation information was employed for detecting the protocol mismatch; however the statistical technique is not limited hereto, and the statistical technique other than it, for example, a mutual information quantity may be employed. The rule-based technique, for example, the technique of using a synonym dictionary instead of the statistical technique is also thinkable. Further, a combination of both techniques may be employed.

### Fourth Embodiment

The fourth embodiment will be explained.

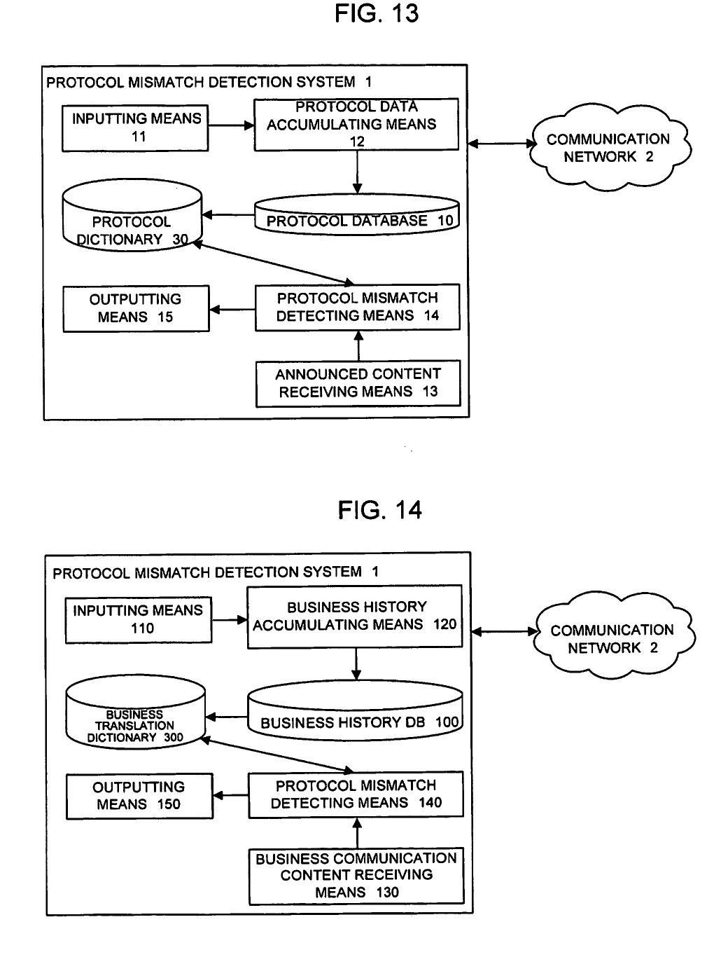

FIG. 13 is a view illustrating a configuration of the entirety of the protocol mismatch detection system 1 relating to the fourth embodiment.

A point in which the protocol mismatch detection system 1 of the fourth embodiment differs from the protocol mismatch detection system 1 of the first embodiment is that it includes a protocol dictionary 30, which is prepared based upon the protocol database 10 of its own system, and the protocol mismatch detecting means 14 detects the mismatch of the protocol by employing the protocol dictionary 30. This raises the speed of the translation all the more as compared with the case of the first embodiment.

### Example 4

The example 4 corresponding to the fourth embodiment will be explained. Additionally, in the example 4, the mail is targeted as a communication form; the telephone correspondence, the conference, or the like is acceptable.

FIG. 14 is a view illustrating a configuration of the entirety of the protocol mismatch detection system relating to the example 4.

The protocol mismatch detection system 1 of the example 4 includes an inputting means 110 for inputting a business communication content, a business history database 100 of its own system, a business history accumulating means 120 for accumulating the inputted business communication content in the business history database 100, a business dictionary 300 that is prepared based upon the business history database, a business communication content receiving means 130 for receiving the business communication content from an outside, a business history database 100, a protocol mismatch detecting means 140 for making a reference to the business dictionary 300, and detecting the mismatch of the protocol of the received business communication content, and an outputting means 150 for outputting a detection result by the protocol mismatch detecting means 140.

Additionally, the inputting means 110 for inputting the business communication content corresponds to the inputting means 11, the business history databases 100 to the protocol database 10, the business history accumulating means 120 to the protocol data accumulating means 12, the business dictionary 300 to the protocol dictionary 30, the business communication content receiving means 130 to the announced content receiving means 13, the protocol mismatch detecting means 140 to the protocol mismatch detecting means 14, and the outputting means 150 to the outputting means 15, respectively. Additionally, it is assumed that the business history prepared from the data such as the mail prepared by the user has been stored in the business history database 100.

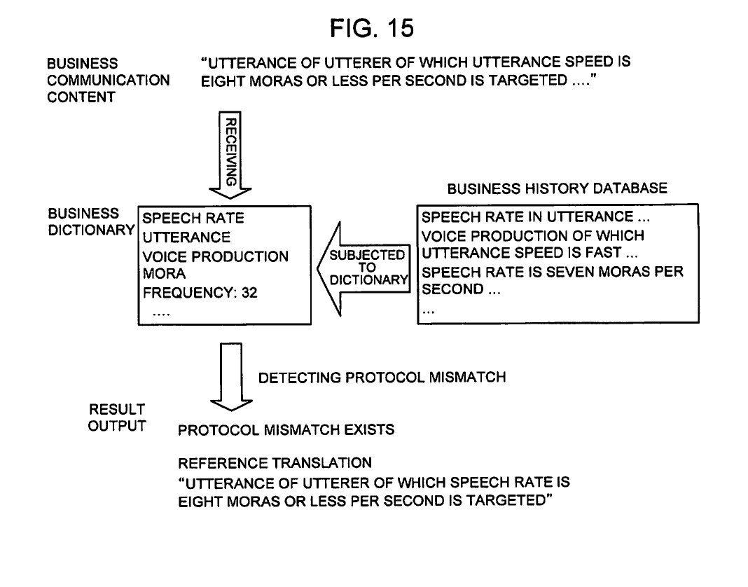

Hereinafter, a specific operation in the configuration as mentioned above will be explained by employing FIG. 15.

It is assumed that Mr. E belonging to a certain group (a user of the protocol mismatch detection system) has received the business communication content saying “an utterance of an utterer of which an utterance speed is eight moras or less per second is targeted . . . ” from a business partner outside a company. At this time, it is assumed that a word set prepared based upon the content of the business history database 100, being a target of detection, has been preserved in the business dictionary 300. For example, when it is assumed that the content saying “a speech rate in an utterance . . . ”, “voice production having a fast utterance speed . . . ”, “a speech rate is seven moras per second . . . ”, or the like has been accumulated in the business history database 100, the business dictionary 300, which has “speech rate”, and “utterance”, “voice production”, “mora per second” and “utterance speed” each of which is a related word thereof, can be prepared, for example, based upon the word collocation information. In addition hereto, for example, information such as “speech rate” (high frequency), and “utterance speed” (low frequency) can be affixed hereto based upon an appearance frequency in the business history database of Mr. E.

The protocol mismatch detecting means 140 makes a reference to the business dictionary 300 for the business communication content received by Mr. E saying “an utterance of an utterer of which an utterance speed is eight moras or less per second is targeted . . . ”, thereby to detect, for example, “utterance speed” as an expression that does not exist in the business dictionary, or an expression of which the appearance frequency quantity is a constant or less, and to regard it as the mismatch of the protocol, and the alarm saying the effect that the mismatch of the protocol exists is outputted, for example, to the screen of Mr. E. The detected alarm may be outputted to a business partner outside a company, being a transmission source. At this time, “utterance speed”, being a portion of the protocol mismatch, may be notified.

In addition hereto, when it is assumed that Mr. E has received the business communication content saying “because an average of a US (Utterance Speed) is seven moras per second, . . . ”, the above content is newly accumulated in the business history database, and the business dictionary is updated by adding “US”, and “mora per second” etc., being a related word thereof, from the word collocation information, together with the appearance frequency, thereby enabling the updated business dictionary to be utilized for detecting the mismatch next time and after it.

In the foregoing example, it was assumed that the word collocation information was employed; however the statistical technique is not limited hereto, and the statistical technique other than it, for example, a mutual information quantity may be employed.

Further, as a unit of the group, an enterprise/a department within an enterprise/an individual within a department are thinkable.

In such a manner, it becomes possible to eliminate the mismatch of the protocol between the different groups, and to realize the efficient communication without pre-preparing the dictionary for translation.

In addition hereto, a configuration may be made so that a translating means is installed, the detected expression of the mismatch is translated, and its result is outputted together with the alarm. For example, it is determined that a possibility that the expression equivalent to “utterance speed” is “speech rate” is high based upon the word collocation information because, herein, the phrases/expressions such as “utterance”, “voice production”, and “mora per second” are related with “speech rate”, and a translation candidate, which assumes that “utterance speed” means “speech rate”, is outputted together with the alarm. Additionally, in the foregoing example, the word collocation information was employed; however the statistical technique is not limited hereto, and the statistical technique other than it, for example, a mutual information quantity may be employed. The rule-based technique, for example, the technique of using a synonym dictionary instead of the statistical technique is also thinkable. Further, a combination of both techniques may be employed.

Further, in this example, it was determined that the mismatch was detected for the expression which did not exist in the business dictionary 300, or for the expression of which the quantity of the appearance frequency was a constant or less, and in addition to this, the business dictionary 300 may include the word or the expression previously known to be a word or expression of which the protocol does not coincide with the protocol of Mr. E.

This application is based upon and claims the benefit of priority from Japanese patent application No. 2007-5060, filed on Jan. 12, 2007, the disclosure of which is incorporated herein in its entirety by reference.

### HOW THE INVENTION IS CAPABLE OF INDUSTRIAL EXPLOITATION

The present invention is applicable to the field such as communication in a project having a form in which plural enterprises/departments/individuals cooperatively perform a business.

1-32. (canceled)

33. A protocol mismatch detection system, comprising:
a first protocol database;
a second protocol database;
a first protocol data accumulating unit for acquiring a content presented by a first user, and accumulating it in said first protocol database;
a second protocol data accumulating unit for acquiring a content presented by a second user, and accumulating it in said second protocol database;
a presented content receiving unit for receiving the content presented by said second user; and
a protocol mismatch detecting unit for, for a certain word being included in the content presented by said second user, making a reference to said first protocol database and said second protocol database, detecting the word positionally close to this certain word from said first protocol database, identifying the word corresponding to said certain word by said first user, and when the identified word does not coincide with the word being included in the content presented by said second user, detecting a mismatch of a protocol.

34. A protocol mismatch detection system according to claim 33, wherein said protocol mismatch detecting unit notifies the mismatch of the protocol.

35. A protocol mismatch detection system according to claim 33, wherein said announced content is one of an electronic mail, a specification, a conference document, minutes of a proceeding, and a content announced in a conference, or a combination thereof.

36. A protocol mismatch detection system according to claim 33, wherein said protocol mismatch detecting unit identifies a target word or a target expression of the protocol mismatch by one of a word collocation frequency, a word mutual information quantity, and a synonym dictionary, or a combination thereof.

37. A protocol mismatch detection system according to claim 33:
wherein it comprises a protocol dictionary prepared based upon the content of the protocol database; and
wherein said protocol mismatch detecting unit detects the mismatch of the protocol by employing said protocol dictionary.

38. A protocol mismatch detection system according to claim 33:
wherein it comprises a protocol dictionary prepared based upon the content of the protocol database; and
wherein said protocol mismatch detecting unit detects a word or an expression of which the protocol coincides, or a word or an expression of which the protocol does not coincide by employing said protocol dictionary.

39. A protocol mismatch detection system according to claim 33, wherein said protocol mismatch detecting unit detects the mismatch of the protocol by employing the protocol database of its own system and the protocol database being publicly opened over a network.

40. A protocol mismatch detection system according to claim 39, said protocol mismatch detection system:
comprising an announced content transmitting unit for transmitting data of the protocol for which the mismatch has been detected to said protocol database being publicly opened over the network; and
accumulating said transmitted data in said protocol database being publicly opened over the network.

41. A protocol mismatch detection system according to claim 34, said protocol mismatch detection system comprising a notifying unit for notifying said notification to the user having received said announced content.

42. A protocol mismatch detection system according to claim 34, said protocol mismatch detection system comprising a notifying unit for notifying said notification to the user having announced said announced content.

43. A protocol mismatch detection system according to claim 33, said protocol mismatch detection system comprising a protocol mismatch collecting unit for collecting the detection of the protocol mismatch.

44. A protocol mismatch detection system, comprising:
a first protocol database;
a second protocol database;
a first protocol data accumulating unit for acquiring a content presented by a first user, and accumulating it in said first protocol database;
a second protocol data accumulating unit for acquiring a content presented by a second user, and accumulating it in said second protocol database;
a presented content receiving unit for receiving the content presented by said second user; and
a protocol mismatch detecting unit for, for a certain word being included in the content presented by said second user, making a reference to said first protocol database and said second protocol database, detecting a position in which said certain word has been used in said first protocol database, identifying the word existing in said position in said second protocol database, and when the identified word does not coincide with the word being included in the content presented by said second user, detecting a mismatch of a protocol.

45. A protocol mismatch detection system according to claim 44, wherein said protocol mismatch detecting unit notifies the mismatch of the protocol.

46. A protocol mismatch detection system according to claim 44, wherein said announced content is one of an electronic mail, a specification, a conference document, minutes of a proceeding, and a content announced in a conference, or a combination thereof.

47. A protocol mismatch detection system according to claim 44, wherein said protocol mismatch detecting unit identifies a target word or a target expression of the protocol mismatch by one of a word collocation frequency, a word mutual information quantity, and a synonym dictionary, or a combination thereof.

48. A protocol mismatch detection system according to claim 44:
wherein it comprises a protocol dictionary prepared based upon the content of the protocol database; and
wherein said protocol mismatch detecting unit detects the mismatch of the protocol by employing said protocol dictionary.

49. A protocol mismatch detection system according to claim 44:
wherein it comprises a protocol dictionary prepared based upon the content of the protocol database; and
wherein said protocol mismatch detecting unit detects a word or an expression of which the protocol coincides, or a word or an expression of which the protocol does not coincide by employing said protocol dictionary.

50. A protocol mismatch detection system according to claim 44, wherein said protocol mismatch detecting unit detects the mismatch of the protocol by employing the protocol database of its own system and the protocol database being publicly opened over a network.

51. A protocol mismatch detection system according to claim 50, said protocol mismatch detection system:
comprising an announced content transmitting unit for transmitting data of the protocol for which the mismatch has been detected to said protocol database being publicly opened over the network; and
accumulating said transmitted data in said protocol database being publicly opened over the network.

52. A protocol mismatch detection system according to claim 45, said protocol mismatch detection system comprising a notifying unit for notifying said notification to the user having received said announced content.

53. A protocol mismatch detection system according to claim 45, said protocol mismatch detection system comprising a notifying unit for notifying said notification to the user having announced said announced content.

54. A protocol mismatch detection system according to one of claim 45, said protocol mismatch detection system comprising a protocol mismatch collecting unit for collecting the detection of the protocol mismatch.

55. A protocol mismatch detection method, comprising:
acquiring a content presented by a first user, and accumulating it in a first protocol database;
acquiring a content presented by a second user, and accumulating it in a second protocol database; and
for a certain word being included in the received content presented by said second user, making a reference to said first protocol database and said second protocol database, detecting the word positionally close to this certain word from said first protocol database, identifying the word corresponding to said certain word by said first user, and when the identified word does not coincide with the word being included in the content presented by said second user, detecting a mismatch of a protocol.

56. A protocol mismatch detection method, comprising:
acquiring a content presented by a first user, and accumulating it in a first protocol database;
acquiring a content presented by a second user, and accumulating it in a second protocol database; and
for a certain word being included in the received content presented by said second user, making a reference to said first protocol database and said second protocol database, detecting a position in which said certain word has been used in said first protocol database, identifying the word existing in said position in said second protocol database, and when the identified word does not coincide with the word being included in the content presented by said second user, detecting a mismatch of a protocol.

57. A recording medium in which a program for detecting a mismatch of a protocol is stored, said program causing an information processing device to execute the processes of:
acquiring a content presented by a first user, and accumulating it in a first protocol database;
acquiring a content presented by a second user, and accumulating it in a second protocol database; and
for a certain word being included in the received content presented by said second user, making a reference to said first protocol database and said second protocol database, detecting the word positionally close to this certain word from said first protocol database, identifying the word corresponding to said certain word by said first user, and when the identified word does not coincide with the word being included in the content presented by said second user, detecting a mismatch of a protocol.

58. A recording medium in which a program for detecting a mismatch of a protocol is stored, said program causing an information processing device to execute the processes of:
acquiring a content presented by a first user, and accumulating it in a first protocol database;
acquiring a content presented by a second user, and accumulating it in a second protocol database; and
for a certain word being included in the received content presented by said second user, making a reference to said first protocol database and said second protocol database, detecting a position in which said certain word has been used in said first protocol database, identifying the word existing in said position in said second protocol database, and when the identified word does not coincide with the word being included in the content presented by said second user, detecting a mismatch of a protocol.

59. A protocol translation system, comprising:
a first protocol database;
a second protocol database;
a first protocol data accumulating unit for acquiring a content presented by a first user, and accumulating it in said first protocol database;
a second protocol data accumulating unit for acquiring a content presented by a second user, and accumulating it in said second protocol database;
a presented content receiving unit for receiving the content presented by said second user;
a protocol mismatch detecting unit for, for a certain word being included in the content presented by said second user, making a reference to said first protocol database and said second protocol database, detecting the word positionally close to the above certain word from said first protocol database, identifying the word corresponding to said certain word by said first user, and when the identified word does not coincide with the word being included in the content presented by said second user, detecting a mismatch of a protocol; and
a translating unit for translating an expression of the detected mismatch.
